(19) United States
(12) Patent Application Publication
(10) Pub. No.: US 2021/0365482 A1
(43) Pub. Date: Nov. 25, 2021

(54) CHAT SYSTEM, CHATBOT SERVER DEVICE, CHATBOT ID MANAGEMENT DEVICE, CHAT MEDIATION SERVER DEVICE, PROGRAM, CHAT METHOD, AND CHAT MEDIATION METHOD

(71) Applicant: JE INTERNATIONAL CORPORATION, Gifu-shi, Gifu (JP)

(72) Inventor: Minsu KIM, Gifu (JP)

(21) Appl. No.: 17/281,536

(22) PCT Filed: Oct. 23, 2019
(86) PCT No.: PCT/JP2019/041442

§ 371 Date: Mar. 30, 2021

(30) Foreign Application Priority Data
Oct. 30, 2018 (JP) 2018-204348

(51) Int. Cl. G06F 16/332; H04L 12/58; G06N 20/00; G06N 5/04

(52) U.S. Cl. CPC G06F 16/3329; G06N 5/04; G06N 20/00; H04L 51/02

(57) ABSTRACT

This chat system (100) is provided with a chatbot ID management unit (23), a chatbot ID reception unit,(16), and an alteration unit (17, 18). The chatbot ID management unit (23) stores therein field data in association with a chatbot ID for identifying a chatbot server device. The chatbot ID reception unit (16) acquires, on the basis of field at a outputted from a Held data deauction unit (36) m response to query data transmitted from a terminal device side, a chatbot ID that is obtained by referencing the chatbot ID management unit (23). On the basis of the chatbot ID acquired by the chatbot ID reception unit (16), the alteration unit (17,18) changes the chatbot server device (3A, 3B, 3C) being the transmission destination of the query data transmitted by a terminal device (6A, 6B, 6C).

### TECHNICAL FIELD

The present disclosure relates to a chat system, chatbot server device, chatbot ID management device, chat mediation server device, program, chat method, and chat mediation method. This application claims priority to Japanese Patent Application No. 2018-204348 filed on Oct. 30, 2018, incorporated herein by reference in its entirety.

### BACKGROUND ART

Using artificial intelligence technology, the use of chatbot server devices that can automatically return an appropriate text response for a text input from a user or the like has expanded greatly. With the use of chatbot server devices, an appropriate response for a variety of text inputs from a user or the like can be returned without putting a lot of work. The chatbot server device has currently been used, for example, for online customer support services or information provision services.

Patent Literature 1 discloses a chatbot server device that learns a relationship between an input text and a response text through machine learning process, and generates an appropriate response text for the input text based on knowledge data as learning results.

### CITATION LIST

### Patent Literature

(Patent Literature 1) Patent Literature 1: Japanese Patent No. 6218057

### DISCLOSURE OF THE INVENTION

### Technical Problem

It is difficult for a server device to output a response text for an input text to all texts. Currently, each chatbot server has performed learning processing specializing in text in the specialty field, and provides a chat service based on learning results.

For example, when a user is chatting (exchange of text) with a certain chatbot server device, conversation tends to digress to different themes from the original one. For example, a query can be more specialized, or digress to other fields. With the existing technology, it is not possible to switch to a better chatbot server device when a user is chatting with a chatbot server device.

The present invention has been made in consideration of the above circumstances, and is to provide a chat system, a chatbot server device, a chat mediation server device, a program, a chat method, and a chat mediation method in order to change the connection to a more appropriate chatbot server device even if a chatbot server device is in middle of a chat service.

### Technical Solution

[1] Various aspects of the present invention are directed to providing a chatbot server device, a chatbot ID management device, and a chat mediation server device. The chatbot server device includes an answer management unit for maintaining data representing a relationship between query data and answer data, a field data management unit for maintaining data representing a relationship between the query data and the field data, which is information on the field to which the query data belongs, and an answer inference unit for making inferences about answer data based on query data transmitted by a terminal device and the answer management unit, a field data inference unit for making inferences about field data based on the query data transmitted by a terminal device and the field data management unit. The chatbot ID management device includes a chatbot ID management unit for storing the field data in association with a chatbot ID for identifying the chatbot server device, and a chatbot ID transmission unit for outputting the chatbot ID corresponding to the field data based on the field data outputted from the chatbot server device inferred by the field data inference unit in response to the query data transmitted by a terminal device. The chat mediation server device includes a query receiving unit for receiving the query data from the terminal device, a query transmission unit for transmitting the query data received by the query receiving unit to the chatbot server device, an answer receiving unit for receiving the answer data inferred by the answer inference unit and the field data inferred by the field data inference unit, an answer output unit for transmitting the answer data received by the answer receiving unit to the terminal device, a field data transmission unit for transmitting the field data received by the answer receiving unit to the chatbot ID management device, a chatbot ID receiving unit for receiving the chatbot ID from the chatbot ID management device in response to the field data transmitted by the field data transmission unit and an alteration unit for changing the chatbot server device that receives the query data transmitted by the terminal based on the chatbot ID received by the chatbot ID receiving unit.

[2] In accordance with an aspect the present invention, the alteration unit in the chat system attempts to obtain an approval as to whether to consider the chatbot server device, which shows the chatbot ID obtained by the chatbot ID receiving unit with respect to the original terminal device that transmitted the query data, as a connection destination and to change the chatbot server device that receives the query data only when the approval is obtained.

[3] According to an embodiment of the present invention, the chatbot server device in the chat system includes storing self-field data corresponding to a self-device and further includes an inference results transmission unit to control outputting the field data to the outside only when the field data inferred by the field data inference data unit is different from the self-field data.

[4] According to another embodiment of the present invention, the field data inference unit in the chatbot server device of the chat system calculates an accuracy indicating the authenticity of the inferred field data. An answer receiving unit in the chat mediation server device receives the accuracy together with the field data and the field data transmission unit transmits the field data to the chatbot ID management device only when the accuracy is equal to or greater than a predetermined threshold. The chatbot ID receiving unit receives the chatbot ID from the chatbot ID management device, and the alteration unit changes the chatbot server device that receives the query data transmitted by the terminal device.

[5] In another embodiment of the present invention, the chatbot server device includes an answer management unit for maintaining data representing a relationship between query data and answer data, a field data management unit for maintaining data representing a relationship between the query data and field data, which is information on a field to which the query data belongs, an answer inference unit for making inferences about answer data based on the query data transmitted by the terminal device and the answer management unit, and a field data inference unit for making inferences about field data based on the query data unit transmitted by a terminal device and the field data management.

[6] In another embodiment of the present invention, the chatbot ID management device includes a chatbot ID management unit for storing field data in association with a chatbot ID for identifying field data, which is information on a field to which query data transmitted by a terminal device as a chat service client belongs, and chatbot server device as a chat service server and a chatbot ID transmission unit for outputting the chatbot ID corresponding to the field data based on the field data outputted from the inferred chatbot server device in response to the query data transmitted by the terminal device.

[7] In addition, a chat mediation server device according to an aspect of the present invention includes a query receiving unit for receiving query data transmitted by a terminal device that is a chat service client, a query transmission unit for transmitting the query data received by the answer receiving unit to the chatbot server device that is a server of the chat service, an answer receiving unit for receiving answer data corresponding to the query data and field data corresponding to the query data as a result inferred by the chatbot server device, an answer output unit for transmitting the answer data received by the answer receiving unit to a terminal device, a field data transmission unit for transmitting the field data received by the answer receiving unit to a chatbot ID management device, and an alteration unit for changing the chatbot server device that receives the query data transmitted by the terminal device based on the chatbot ID received by the chatbot ID receiving unit.

[8] An exemplary embodiment of the present disclosure provides a computer-readable program stored in medium for causing a computer to function as a chatbot server device, the chatbot server device, comprising: an answer management unit for maintaining data representing a relationship between query data and answer data, a field data management unit for maintaining data representing a relationship between the query data and field data, which is information on the field to which the query data belongs, an answer inference unit for making inferences about answer data based on the query data transmitted by a terminal device and the answer management unit, and a field data inference unit for making inferences about field data based on the query data transmitted by a terminal device and the field data management.

[9] An exemplary embodiment of the present disclosure provides a computer-readable program stored in medium for a computer to function as a chatbot ID management device, the chatbot ID management device, comprising: a chatbot ID management unit for storing the field data in association with a chatbot ID for identifying the chatbot server device, and a chatbot ID transmission unit for outputting the chatbot ID corresponding to the field data based on the field data outputted from the chatbot server device inferred by the field data inference unit in response to the query data transmitted by a terminal device.

[10] An exemplary embodiment of the present disclosure provides a computer-readable program stored in medium for a computer to function as a chatbot mediation server device, the chatbot mediation server device, comprising: a query receiving unit for receiving the query data from the terminal device, a query transmission unit for transmitting the query data received by the query receiving unit to the chatbot server device, an answer receiving unit for receiving the answer data inferred by the answer inference unit and the field data inferred by the field data inference unit, an answer output unit for transmitting the answer data received by the answer receiving unit to the terminal device, a field data transmission unit for transmitting the field data received by the answer receiving unit to the chatbot ID management device, a chatbot ID receiving unit for receiving the chatbot ID from the chatbot ID management device in response to the field data transmitted by the field data transmission unit and an alteration unit for changing the chatbot server device that receives the query data transmitted by the terminal based on the chatbot ID received by the chatbot ID receiving unit.

[11] An embodiment of the present invention provides a chat method for executing a chat service. In the chatbot server device, which is a server of the chat service, a field data management unit stores data representing the relationship between query data and answer data, an answer management unit stores data representing the relationship between the query data and field data, which is information on the field to which the query data belongs and an answer inference unit infers field data based on the query data transmitted by the terminal device as the chat service client and the answer management unit. For a chatbot ID management device to provide a chatbot ID based on the field data, the chatbot ID management unit stores the field data in association with a chatbot ID for identifying the chatbot server device. For the chat mediation server device to which the terminal device is connected, a chatbot ID receiving unit includes obtaining the chatbot ID with reference to the chatbot ID management unit based on the field data outputted from the field data inference unit in response to the query data transmitted by the terminal device.

[12] Another embodiment of the present invention provides a chat mediation method where a chat mediation server device mediates between a terminal device and chatbot server device. A query receiving unit receives a query from the terminal device, and a query transmission unit transmits the query received by the query receiving unit to the selected chatbot server device. An answer receiving unit receives an inference result, which is a result of inference processing based on a query, from the chatbot server device to which the query is transmitted. The inference result includes an accuracy indicating the authenticity of the field data and the data related to the aforementioned answer and query. The field data transmission unit transmits field data included in the inference results to the chatbot ID management device only when the accuracy received by the answer receiving unit is above a predetermined threshold. A chatbot ID receiving unit receives a chatbot ID corresponding to the transmitted field data from the chatbot ID management device. The chatbot ID represents a candidate for changing the connection destination of the chatbot server device. The answer output unit (14) transmits the answer included in the inference result to the terminal device. When the chatbot ID receiving unit receives the chatbot ID, an alteration unit changes the chatbot server device that receives the query data transmitted by the terminal device based on the chatbot ID obtained by the chatbot ID receiving unit.

### Advantageous Effects

According to the present invention, for example, in order to provide better information, it becomes possible to dynamically change a chatbot server device of the connection destination. That is, for example, more detailed information and more specialized information can be provided to a user.

### BRIEF DESCRIPTION OF THE DRAWINGS

FIG. 1 is a block diagram showing a device configuration of a chat system according to an embodiment of the present invention.

FIG. 2 is a block diagram showing a schematic functional configuration of the chat mediation server device according to the embodiment.

FIG. 3 is a block diagram showing a schematic functional configuration of the chatbot ID management device according to the embodiment.

FIG. 4 is a block diagram showing a schematic functional configuration of the chatbot server device according to the embodiment.

FIG. 5 is a schematic diagram showing an example of a series of operation procedures of the chat system according to the embodiment.

FIG. 6 is a schematic diagram showing an example of displaying chat contents on the terminal device display unit in the same embodiment.

FIG. 7 is a flowchart (flowchart 1) showing the processing procedure of the chat mediation server device in the embodiment.

FIG. 8 is a flowchart (flow chart 2) showing the processing procedure of the chat mediation server device in the same embodiment.

FIG. 9 is a flowchart showing the processing procedure of the chatbot ID management device in the embodiment.

FIG. 10 is a flowchart showing the processing procedure of the chatbot server device in the embodiment.

FIG. 11 is a schematic diagram showing an example of the configuration of field data in the embodiment.

### MODE FOR CARRYING OUT THE INVENTION

Next, this invention has been described in connection with what is presently considered to be practical exemplary embodiments with reference to the drawings.

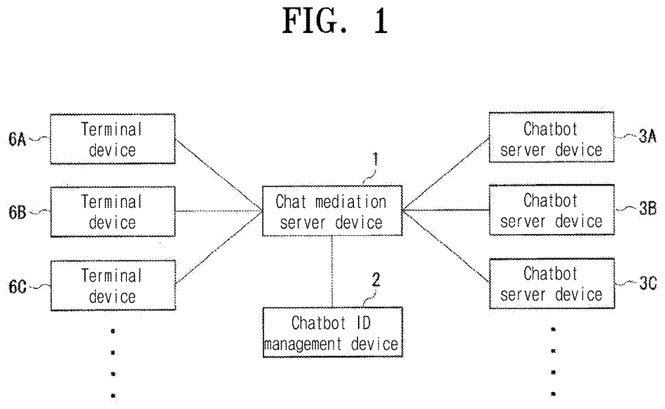

FIG. 1 is a block diagram showing the device configuration of a chat system according to the present embodiment. As shown, a chat system 100 includes a chat mediation server device 1, a chatbot ID management device 2, a plurality of chatbot server devices 3A, 3B, . . . , and a plurality of terminal devices 6A, 6C, . . . . In the figure, three chatbot server devices and three terminal devices are shown, but each number is arbitrarily assigned. The chat system 100 is typically configured to include a plurality of chatbot server devices and a plurality of terminal devices. In addition, each of the chatbot server devices 3A, 3B, . . . is often referred to as a chatbot server device 3. In addition, each of the terminal devices 6A, 6B, 6C, . . . is often referred to as a terminal device 6.

In addition, “ID” (an abbreviation for identifier, identification) means an identifier and identification information.

In the illustrated chat system 100, devices are communicated using, for example, Internet Protocol IP.

A chat system 100 generally functions as follows. A terminal device 6 transmits a query to the chatbot server device 3 via the chat mediation server device 1. The chatbot server device 3 outputs an answer in response to the received query. An answer output from the chatbot server device 3 is sent to the terminal device 6 via the chat mediation server device 1. A chat service is established by a query from the terminal device 6 and an answer from the chatbot server device 3. The query from the terminal device 6 and the answer from the chatbot server device 3 may be repeated a plurality of times. Each of the chatbot server devices 3 returns good answers to queries in a specific field. The difference is made depending on the knowledge learned by each chatbot server device 3 or the like.

Among multiple chatbot server devices 3, a chatbot server device 3 to which a query from a terminal device 6 is transmitted is appropriately selected. In the middle of a chat service, a chat mediation server device 1 may change the target chatbot server device 3 to send a query.

A chat mediation server device 1 mediates a terminal device 6 and a chatbot server device 3. A chatbot ID management device 2 manages the chatbot ID, which is information identifying the chatbot server device 3. In addition, the chatbot ID management device 2 manages information of field data in a form in association with the chatbot ID. A field data is information indicating the field of chat content (content of query). In addition, field data is also called intents.

A chatbot server device 3 returns an answer according to a query received from the outside. The chatbot server device 3 further infers field data based on the query, and returns inference result information, for example, one-to-one correspondence information.

A terminal device 6 is a device that functions as a client of a chat service. A user operates the terminal device 6, gets access to (connects) a chat mediation server device 1, and performs a chat. Specific examples of the terminal device 6 are a PC (personal computer), a tablet terminal, a smartphone (cell phone), a wristwatch type terminal device, and the like.

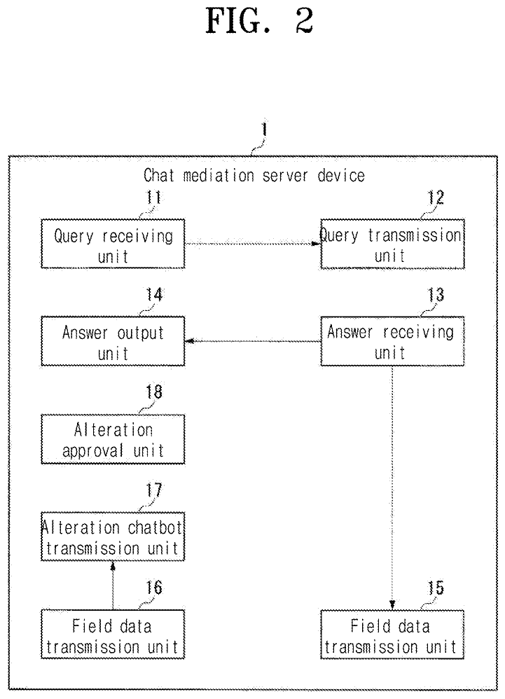

FIG. 2 is a block diagram showing a schematic functional configuration of the chat mediation server device 1. As shown, the chat mediation server device 1 is configured to include a query receiving unit 11, a query transmission unit 12, an answer receiving unit 13, an answer output unit 14, and a field data transmission unit 15, a chatbot ID receiving unit 16, a change chatbot information transmission unit 17, and an alteration approval unit 18.

In addition, a chat mediation server device 1 stores and manages information about a chat thread for each terminal device 6. Specifically, the chat mediation server device 1 stores information for identifying the chatbot server device 3 as a connection destination (connection target) for each terminal device 6. The chatbot server device 3, which is a connection destination from the terminal device 6, may be appropriately changed.

A query receiving unit 11 receives the query transmitted by the terminal device 6.

A query transmission unit 12 transmits the query received by a query receiving unit 11 to the chatbot server device 3.

In addition, among the plurality of chatbot server devices 3, a chatbot server device 3 to which the query transmission unit 12 transmits a query (receives a query) is determined by a predetermined method. For example, a user may determine the connection destination chatbot server device 3 by selecting on the screen of the terminal device 6. Alternatively, the chat app executing on the terminal device 6 may determine the connection destination chatbot server device 3 by analyzing the content of the query. In addition, in a situation in which chat is already started between the terminal device 6 and the specific chatbot server device 3, the chatbot server device 3 same as the last (previous) connection is determined as a connection destination. In addition, even in a situation in which chat between the terminal device 6 and a specific chatbot server device 3 is already started, the connection destination chatbot server device 3 can be changed by the following method.

An answer receiving unit 13 receives an answer transmitted by a chatbot server device 3. This answer is generated by the chatbot server device 3 in response to a query sent to the chatbot server device 3. In addition, the answer receiving unit 13 may receive field data from the chatbot server device 3 together with the answer. When receiving field data, the answer receiving unit 13 also receives data of accuracy of the field data. The accuracy indicates the authenticity of the field data, and is outputted from the chatbot server device 3. The accuracy is expressed as a value of 0% or more and 100% or less, for example.

An answer output unit 14 transmits an answer received by an answer receiving unit 13 to a terminal device 6 as a source of query transmission.

A field data transmission unit 15 transmits the information of the field data received by an answer receiving unit 13 to a chatbot ID management device 2.

A chatbot ID receiving unit 16 receives a chatbot ID transmitted by a chatbot ID management device 2 in response to information of field data transmitted by a field data transmission unit 15.

An alteration chatbot information transmission unit 17 transmits the chatbot ID received by a chatbot ID receiving unit 16 to a terminal device 6. Thereby, the alteration chatbot information transmission unit 17 introduces the changeable chatbot ID to the terminal device 6.

With respect to a chatbot ID transmitted by an alteration chatbot information transmission unit 17 to a terminal device 6, an alteration approval unit 18 receives information from the terminal device 6 about whether to approve the alteration to a chatbot server device 3 related to the chatbot ID.

When an alteration to a chatbot ID is approved, an alteration approval unit 18 changes a chatbot server device 3 of the connection destination to which the terminal device 6 is connected. In addition, the alteration approval unit 18 instructs a query transmission unit 12 to retransmit the last query content from the terminal device 6 to the alteration destination chatbot server device 3. When the alteration to the chatbot ID is not approved, the chatbot server device 3 of the current connection destination of the chat device 6 is maintained as it is.

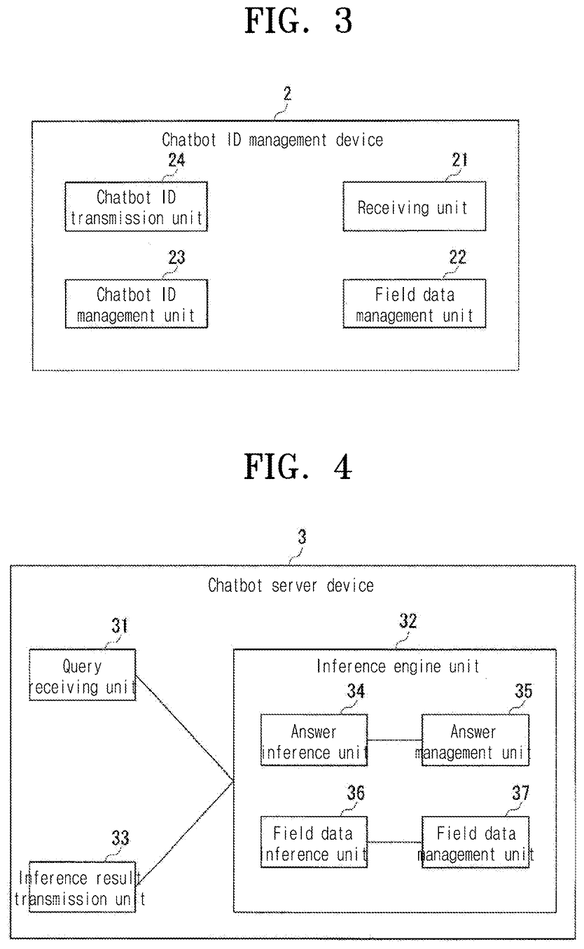

FIG. 3 is a block diagram showing a schematic functional configuration of the chatbot ID management device 2. As shown, the chatbot ID management device 2 includes a receiving unit 21, a field data management unit 22, a chatbot ID management unit 23, and a chatbot ID transmission unit 24.

A receiving unit 21 receives field data information from a chat mediation server device 1.

A field data management unit 22 stores and manages information on field data. Specifically, the field data management unit 22 stores at least information identifying the field data in association with the chatbot ID. For example, the field data and the chatbot ID correspond on a one-to-one basis. Moreover, one chatbot ID may correspond to data in multiple fields. That is, the field data management unit 22 may output information on the chatbot ID related to the field data received by a receiving unit 21.

A chatbot ID management unit 23 stores and manages information on the chatbot ID. It may be considered that the chatbot ID management unit 23 stores the chatbot ID in association with the aforementioned field data.

A chatbot ID transmission unit 24, with reference to a field data management unit 22 and a chatbot ID management unit 23, transmit the chatbot ID to a chat mediation server device 1 when there is a chatbot ID corresponding to the field data received by a receiving unit 21. This chatbot ID identifies a chatbot server device 3 that can replace the chatbot server device 3 currently providing a chat service.

FIG. 4 is a block diagram showing a schematic functional configuration of a chatbot server device 3. As shown, the chatbot server device 3 includes a query receiving unit 31, an inference engine unit 32, an inference result transmission unit 33, an answer inference unit 34, and an answer management unit 35, a field data inference unit 36, and a field data management unit 37. In addition, the answer inference unit 34, the answer management unit 35, the field data inference unit 36, and the field data management unit 37 are included in the inference engine unit 32.

A query receiving unit 31 receives a query from a chat mediation server device 1. This query is originally a query transmitted by a terminal device 6.

An inference engine unit 32 makes an inference processing based on the query received by a query receiving unit 31. The inference engine unit 32 outputs answers or field data as a result of inference. Specifically, for example, the inference engine unit 32 is realized using artificial intelligence technology. That is, the inference engine unit 32 for maintaining the pre-learned model, calculates (or selects) the most suitable answer or field data for an input query based on the model and outputs it. In this case, the inference engine unit 32 may output data which is an accuracy value (eg, 0% or more or 100% or less) of the field data.

An inference algorithm itself (including the machine learning process) by the inference engine unit 32 can be realized using existing technology. An inference result transmission unit 33 transmits the inference result by an inference engine unit 32 to the chat mediation server device 1. Specifically, the inference result transmission unit 33 transmits the answer and field data corresponding to the query received by a query receiving unit 31 with the maximum likelihood to the chat mediation server device 1.

In addition, the chatbot server device 3 originally stores information of field data that it can correspond. An inference result transmission unit 33 transmits the information of the field data to a chat mediation server device 1 only when the field data that it can correspond to is different from the field data output as the inference result by an inference engine unit 32. The chatbot server device 3 transmits an answer, which is an inference result, to the chat mediation server device 1 regardless of what field data of the inference result is. As described above, the answer transmitted by the inference result transmission unit 33 to the chat mediation server device 1 is transmitted to a terminal device 6 that transmitted the original query.

In addition, the functions of each unit included in an inference engine unit 32 are as follows.

An answer inference unit 34 outputs an answer corresponding to the input query with reference to the model maintained by the answer management unit 35.

An answer management unit 35 maintains and manages a model that inputs a query and outputs an answer. This model is machine-learned in advance. In addition, this model can be trained online during a chat.

A field data inference unit 36 outputs field data corresponding to an input query with reference to the model maintained by a field data management unit 37. At this time, the field data inference unit 36 outputs data of accuracy indicating the authenticity of the field data together with the output field data. The field data inference unit 36 calculates accuracy in the process of inferring field data.

A field data management unit 37 maintains and manages a model for outputting field data by inputting a query. This model is machine-learned in advance. In addition, this model can be trained online during a chat.

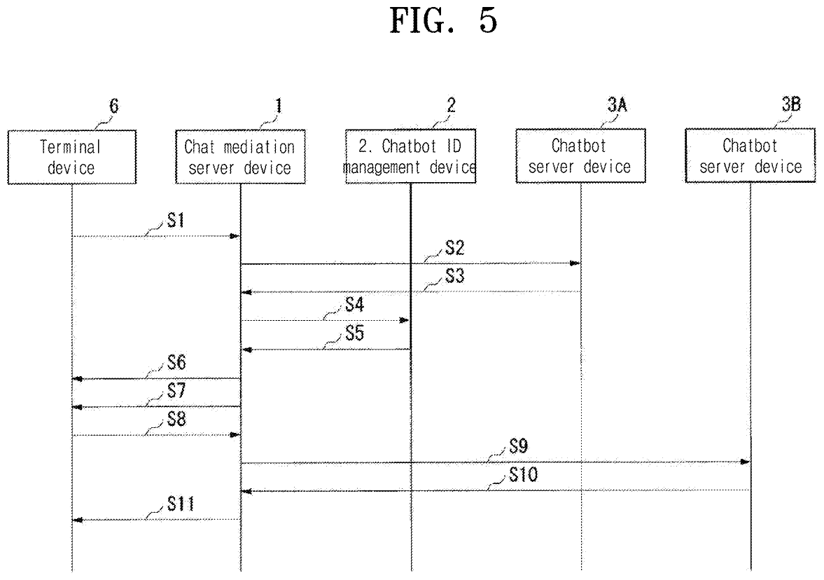

Next, an example of the operation sequence of a chat system 100 will be described. FIG. 5 is a schematic diagram showing an example of an operation procedure by a chat system. According to the example shown here, a terminal device 6 performs a chat with a chatbot server device 3 via the chat mediation server device 1. In the first step, the terminal device 6 exchanges queries and answers with the chatbot server device 3A. Then, the terminal device 6 switches the connection destination to the chatbot server device 3B in the middle of a chat service. After switching, queries and answers are exchanged with the chatbot server device 3B. Hereinafter, it demonstrates according to the order of this drawing.

In step S1, the terminal device 6 transmits a query to the chat mediation server device 1. The chat mediation server device 1 receives the query.

In step S2, the chat mediation server device 1 transmits (delivers) the query received in step S1 to the chatbot server device 3A. In this step, the chatbot server device 3 to which the chat mediation server device 1 sends a query is appropriately selected from a plurality of devices. Specifically, the chatbot server device 3 of transmission destination is predetermined or selected on the terminal device 6. The chatbot server device 3A receives the transmitted query. A chatbot server device 3A infers answers and field data based on the received query.

In step S3, the chatbot server device 3A transmits the answer and field data (including data of accuracy of field data) as a result of inference to the chat mediation server device 1. The chat mediation server device 1 receives such answers and field data.

In step S4, the chat mediation server device 1 transmits the field data received from the chatbot server device 3A to the chatbot ID management device 2. The chatbot ID management device 2 receives information on the field data.

A chatbot ID management device 2 specifies the chatbot ID corresponding to the field data based on the received field data information.

When the chat mediation server device 1 has not received the field data information from the chatbot server device 3A, the processing of this step S4 may be omitted. In addition, even when the accuracy of the field data received by the chat mediation server device 1 is less than a predetermined threshold, the processing of this step S4 may be omitted.

In step S5, the chatbot ID management device 2 transmits the chatbot ID corresponding to the field data received in step S4 to the chat mediation server device 1. This chatbot ID is an ID corresponding to the chatbot server device 3 that can replace the chatbot server device 3A.

In step S6, the chat mediation server device 1 transmits the answer received in step S3 to the terminal device 6 of the query sender. The terminal device 6 receives this answer. The terminal device 6 presents the answer to the user by displaying the answer on a screen or reading it by a synthesized voice.

In step S7, the chat mediation server device 1 transmits the chatbot ID (and information related to the chatbot ID) received in step S5 to the terminal device 6. The terminal device 6 receives this chatbot ID or the like. The terminal device 6 proposes to the user to change the connected chatbot server device 3 by displaying the received chatbot ID or the like on a screen, for example.

In addition, if the chat mediation server device 1 has not received the chatbot ID in step S5, or if the chatbot ID received by the chat mediation server device 1 indicates the current chatbot server device, the processing of step S7 may be omitted.

In step S8, the terminal device 6 transmits information indicating whether or not the chatbot server device 3 is changed to the chat mediation server device 1.

This example shows that the chatbot server device of connection destination is changed from a chatbot server device 3A to a chatbot server device 3B.

In step S9, the chat mediation server device 1 retransmits the query received in step S1 to the chatbot server device 3B as a connection alteration destination. The chatbot server device 3B receives the query. The chatbot server device 3B infers answer and field data based on the received query.

In step S10, the chatbot server device 3B transmits the answer as a result of inference to the chat mediation server device 1. The chat mediation server device 1 receives this answer.

In step S11, the chat mediation server device 1 transmits the answer received in step S10 to the terminal device 6 of query sender. The terminal device 6 receives this answer. The terminal device 6 presents the answer to the user by displaying the answer on a screen or reading it by a synthesized voice.

As described above, the series of processing of the chat system 100 is ended.

However, the terminal device 6 may further transmit a query. When the terminal device 6 further transmits a query, the chat mediation server device 1 transmits the query to the chatbot server device 3B, which is a connection destination at that time. In addition, the exchange of queries and answers can be repeated.

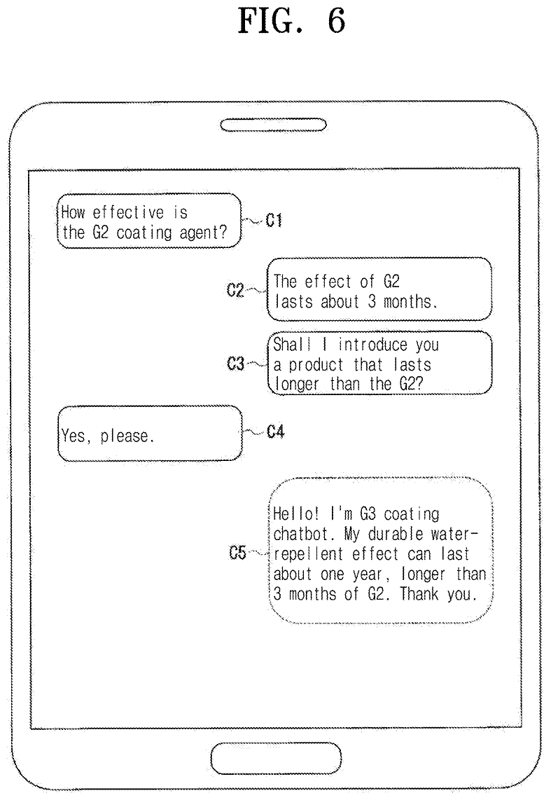

FIG. 6 is a schematic diagram showing an example of display on a display portion of the terminal device 6 (for example, a liquid crystal display with a touch panel function) corresponding to a sequence of operations of a chat. Hereinafter, it demonstrates according to the display example of the figure.

C1 in FIG. 6 corresponds to step S1 in FIG. 5 and is data of a query transmitted by the terminal device 6. The content of the C1 query is “How effective is the G2 coating?”

C2 of FIG. 6 corresponds to step S6 of FIG. 5 and is data of an answer received by the terminal device 6. The answer of C2 is “The effect of G2 lasts about 3 months.”

C3 of FIG. 6 corresponds to step S7 of FIG. 5 and is data of the chatbot ID of the alteration destination candidate (and information related to the chatbot ID) received by the terminal device 6. As a text data to suggest a change to the chatbot ID of alteration destination candidate, the text C3 displayed on the screen of the terminal device 6 is “Shall I introduce you a product that lasts longer than the G2?” The text data displayed at this time, for example, is provided from the chatbot ID management device 2.

C4 of FIG. 6 corresponds to step S8 of FIG. 5 and is data of alteration approval (affirmation) transmitted by the terminal device 6. The content of C4 is “Yes, please.”

C5 of FIG. 6 corresponds to step S11 of FIG. 5 and is data of the answer received by the terminal device 6 from the chatbot server device after the change. The answer of C5 is “Hello!I'm G3 coating chatbot. My durable water-repellent effect can last about one year, longer than 3 months of G2. Thank you.”

In addition, as described above, in the example shown in FIG. 6, the connection destination of the chatbot server device is being changed based on the field data inferred from the query C1. In this example, the field data inferred from the query of C1 corresponds to “G2 Coating agent”-“Persistent Effect”. Further, the field data of “G2 coating agent”-“continuous effect” is related to the chatbot ID of the G3 coating agent chatbot. Accordingly, the answer of C2 is returned to the query of C1 at the same time as the connection change to the chatbot server device of the G3 coating agent for C2 is proposed. Thus, in the case where there is a significant feature in the “continuous effect” of the “G3 coating agent” as compared to the “G2 coating agent”, the user who transmitted a query regarding the field of “G2 coating agent”-“continuous effect” may be guided to the “G3 coating agent” chatbot server device.

Next, processing procedures of each of the main devices comprising a chat system 100 will be described.

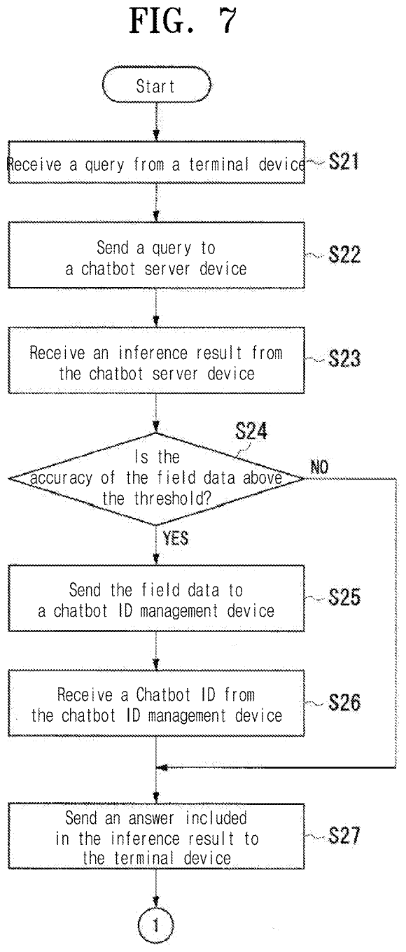

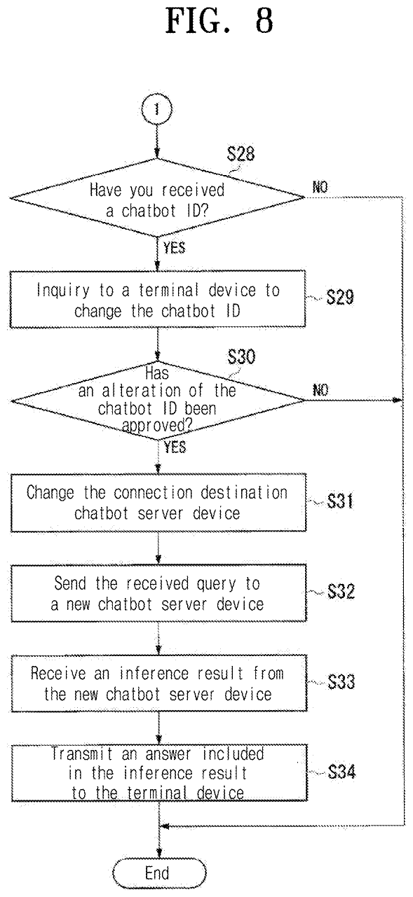

FIGS. 7 and 8 are flowcharts showing the processing procedure of the chat mediation server device 1. FIGS. 7 and 8 are one flow chart showing, the first half and the second half, respectively. This flowchart shows a processing corresponding to a single query transmitted by the terminal device 6. Hereinafter, it demonstrates according to this flowchart.

First, in step S21 of FIG. 7, the query receiving unit 11 of the chat mediation server device 1 receives one query from one terminal device 6.

In step S22, the query transmission unit 12 of the chat mediation server device 1 sends (transmits) the query received in step S21 to the selected chatbot server device 3.

In step S23, the answer receiving unit 13 of the chat mediation server device 1 receives an inference result, which is a result of inference processing based on the query, from the chatbot server device 3, which is a transmission destination in step S22. The inference result includes the answer to the query. Also, the inference result may include field data related to the query. Also, when the inference result includes field data, the inference result may contain an accuracy to indicate the authenticity of the field data.

In step S24, the chat mediation server device 1 determines whether or not the accuracy of the field data is equal to or greater than a predetermined threshold based on the inference result received in step S23. The threshold for accuracy is, for example, 60%. But other values may be used as the threshold for accuracy. When the accuracy of the field data is greater than or equal to the threshold (step S24: YES), the process moves to the next step S25. When the accuracy of the field data is less than the threshold (step S24: NO), the process moves to step S27.

In the case of the above “step S24:YES”, the processing of the following steps S25 and S26 is executed.

In step S25, the field data transmission unit 15 of the chat mediation server device 1 transmits the field data included in the inference result to the chatbot ID management device 2.

And in step S26, the chatbot ID receiving unit 16 of the chat mediation server device 1 receives the chatbot ID (and data related to the chatbot ID) corresponding to the field data transmitted in step S25 from the ID management device 2. The chatbot ID received here is identification information indicating a candidate for changing the connection destination of the chatbot server device 3.

In step S27, the answer output unit 14 of the chat mediation server device 1 transmits the answer included in the inference result received in step S23 to the terminal device 6.

Referring to FIG. 8, in step S28, the chat mediation server device 1 determines whether or not the chat mediation server device 1 receives a chatbot ID from the chatbot ID management device 2 (step S26) regarding the current query. When the chat mediation server device 1 has received the chatbot ID (step S28: YES), the process moves to the next step S29. When the chat mediation server device 1 has not received the chatbot ID (step S28: NO), the entire process of this flowchart is ended.

In addition, the “step S28: NO” is a case where the determination result in step S24 is “NO”.

In step S29, the alteration chatbot information transmission unit 17 of the chat mediation server device 1 inquires of the terminal device 6 for a change to the chatbot ID received in step S25. In other words, the alteration chatbot information transmission unit 17 transmits (a message to inquire whether or not to switch the connection) from the previous connection to the new connection destination chatbot server device 3 specified by the chatbot ID to the terminal device 6. The text of this message is managed by the chatbot ID management device 2, for example, and is received by the chatbot ID receiving unit 16 in step S25.

In step S30, the alteration approval unit 18 of the chat mediation server device 1 receives a response from the terminal device 6 in response to the inquiry made in step S29. Further, the alteration approval unit 18 determines whether or not the received response from the terminal device 6 approves the change of the connection destination of the chatbot server device. If the change of the connected chatbot ID is approved (step S30: YES), the process moves to the next step S31. If not (step S30: NO), the chat mediation server device 1 ends the entire process of this flowchart.

That is, the alteration chatbot information transmission unit 17 and the alteration approval unit 18 operate in cooperation, attempting to obtain approval of whether or not the chatbot server device 3 indicated by the chatbot ID acquired by the chatbot ID receiving unit 16 is used as a connection destination for the original terminal device that has transmitted the query data. Only when this approval is obtained, the alteration approval unit 18 changes the chatbot server device 3 to which the query is transmitted (the processing after step S31 below).

In the case of “step S30:YES”, the following processes from step S31 to S34 are performed.

In step S31, the alteration approval unit 18 of the chat mediation server device 1 changes the chatbot server device 3, which is a connection destination from the terminal device 6, based on the chatbot ID approved for alteration. Information for accessing (connection) a new chatbot server device 3 (e.g., URL (universal resource locator), etc.) is stored in the chat mediation server device 1 in advance in association with the chatbot ID. Alternatively, the chat mediation server device 1 may receive information for accessing the new chatbot server device 3 from the chatbot ID management device 2 when necessary.

In step S32, the query transmission unit 12 of the chat mediation server device 1 transmits (retransmits) the query received from the terminal device 6 in step S21 to the newly connected chatbot server device 3.

In step S33, the answer receiving unit 13 of the chat mediation server device 1 receives an inference result (answer) corresponding to the query from the chatbot server device 3 that receives the query sent in step S32. Although the same query is asked, the inference result (answer) received in step S23 and the inference result (answer) received in step S33 are usually different, for each result is inferred by different chatbot server devices 3.

In step S34, the answer output unit 14 of the chat mediation server device 1 transmits the answer received in step S33 to the terminal device 6.

As described above, the chat mediation server device 1 ends the processing shown in this flowchart (processing for one query from the terminal device 6).

That is, in the chat mediation server device 1, the answer receiving unit 13 receives the field data and accuracy indicating the authenticity of the field data, and only when the accuracy is equal to or greater than a predetermined threshold, the field data transmission unit 15 transmits the field data to the chatbot ID management device 2, the chatbot ID receiving unit 16 receives the chatbot ID from the chatbot ID management device 2, and the alteration unit is to change the chatbot device 3 that receives the query data transmitted by the terminal device 6.

In other words, the chat mediation method shown in the above flowchart is as follows. That is, a query receiving unit receives a query from the terminal device, a query transmission unit transmits the query received by the query receiving unit to a selected chatbot server device, and the answer receiving unit receives an inference result, which is a result of inference based on the queries from the chatbot server device which is a query transmission destination. Further, the inference result includes an answer to the query and accuracy indicating the authenticity of the field data related to the query and the field data, and the field data transmission unit transmits field data included in the inference result to the chatbot ID management device only when is equal to or greater than a predetermined threshold. Meanwhile, the chatbot ID receiving unit receives the chatbot ID corresponding to the field data transmitted by the chatbot ID management device, and the chatbot ID represents a candidate for changing the connection destination of the chatbot server device. An answer output unit 14 transmits the answer included in the inference result to the terminal device, and when the chatbot ID receiving unit has received the chatbot ID, an alteration unit, based on the chatbot ID obtained by the chatbot ID receiving unit, changes the chatbot server device that receives the query data transmitted by the terminal device.

Further, as a modified example of the flowchart described above, the following processing may be performed. That is, in the determination process of step S24, it is better to determine whether or not field data is included in the received inference result. And if the field data is included in the received inference result, a branch is performed to “Step S24:YES”, and if the field data is not included in the received inference result (When field data is not transmitted by the chatbot server device 3, that is when the chatbot server device 3 determines that the query being processed is low in the field of its own device), it branches to “Step S24: NO”.

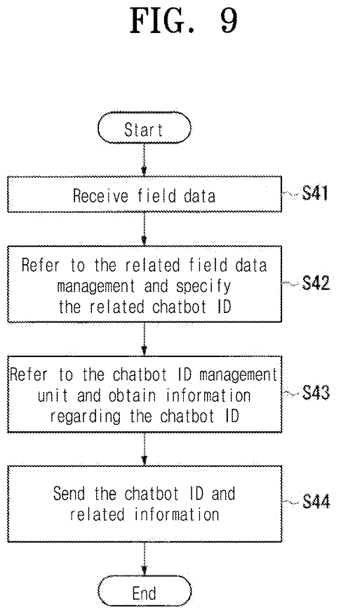

FIG. 9 is a flowchart showing the processing procedure of the chatbot ID management device 2. This flowchart shows a one-time processing procedure how to correspond to the reception of field data from the chat mediation server device 1.

In step S41, the receiving unit 21 of the chatbot ID management device 2 receives information of field data from the chat mediation server device 1.

In step S42, the chatbot ID management device 2 refers to the field data management unit 22, and specifies the chatbot ID related to the field data received in step S41.

In step S43, the chatbot ID management device 2 acquires information on the chatbot ID specified in step S42 as a key. Information on the chatbot ID may include, for example, the name of the chatbot server device, access information (URL, etc.) to get access to the chatbot server device, or contain text information and the like transmitted to the terminal device 6 when confirming a change in the connection destination to the chatbot server device.

In step S44, the chatbot ID transmission unit 24 of the chatbot ID management device 2 transmits the chatbot ID obtained in step S42 and the related information of the chatbot ID obtained in step S43, to the chat mediation server device 1 as requested.

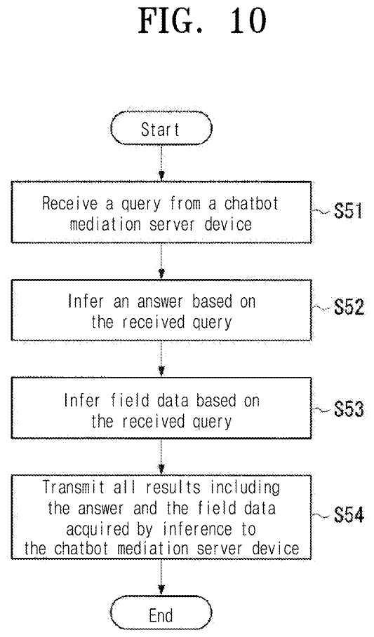

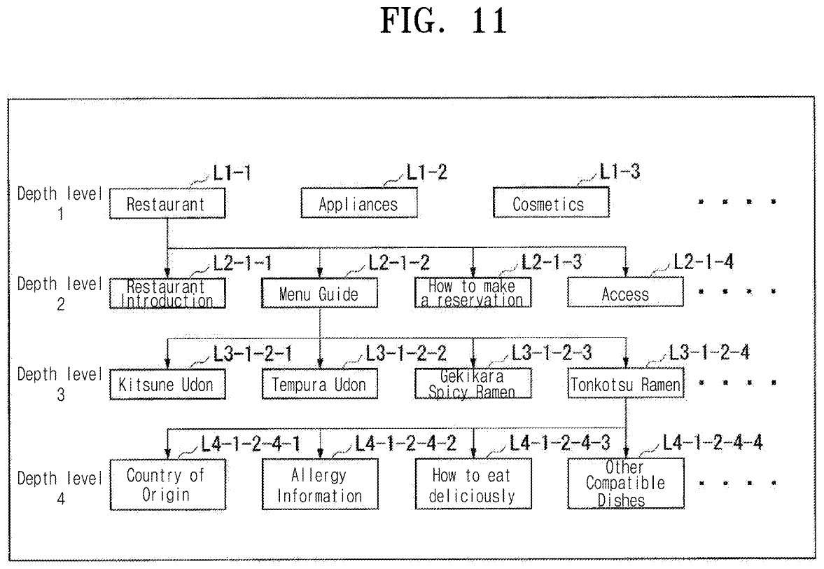

FIG. 10 is a flowchart showing a one-time processing procedure of the chatbot server device 3. This flowchart shows a process how to correspond to the reception of one query transmitted by the chat mediation server device 1. In addition, a machine learning model (a model for answer inference, etc.) included in the chatbot server device 3 is learned in advance.

In step S51, the query receiving unit 31 of the chatbot server device 3 receives a query transmitted by the chat mediation server device 1.

In step S52, the answer inference unit 34 of the chatbot server device 3 infers an answer based on the query received in step S51. At this time, the answer inference unit 34 refers to the answer by referring to the machine-learned model stored in the answer management unit 35.

In step S53, the field data inference unit 36 of the chatbot server device 3 infers field data based on the query received in step S51. At this time, the field data inference unit 36 refers to the field data by referring to the machine-learned model stored in the field data management unit 37.

In step S54, the inference result transmission unit 33 of the chatbot server device 3 transmits the answer obtained in step S52 and the field data obtained in step S53 together as an inference result to the chat mediation server device 1 of the sender.

In addition, the chatbot server device 3 may store self-field data information indicating fields to which the self-device can respond in advance. Then, the chatbot server device 3 may determine whether or not the obtained field data as the inference result in step S53 matches with the own field data previously stored. When both of them match each other, the inference result transmission unit 33 transmits, for example, information indicating that both are identical to the chat mediation server device 1 together with the inference result. Alternatively, when both of them match each other, the inference result transmission unit 33 omits transmitting, for example, field data that is the inference result to the chat mediation server device 1. In this way or in another way, the chatbot server device 3 of the connection destination may be changed more than necessary. Such burden may be reduced by transmitting the information that the field data as a result of the inference and the field data match to the chat mediation server device 1.

Next, one embodiment of field data will be described.

FIG. 11 is a schematic diagram showing an example of the structure of field data. As shown, the set of field data has a tree structure of multiple layers (four layers in the illustrated example). Each node of this tree corresponds to field data to which the chatbot server device 3 corresponds. In some nodes, the upper node (parent node, etc.) corresponds to the upper concept of the field, and the lower node (child node, etc.) corresponds to the lower concept of the field.

In the example of the illustrated tree, nodes in fields such as “restaurant”, “home appliance”, “cosmetics” and the like are included in the highest hierarchy (depth level 1). Among the nodes of the depth level 1, nodes in fields such as “Restaurant Introduction”, “Menu guide”, “How to make reservation”, and “Access” are included in the next layer (depth level 2) as the children node of “Restaurant”. Among the nodes of depth level 2, nodes in fields such as “Kitsune Udon”, “Tempura Udon”, “Gekikara Spicy Ramen”, “Donkotsu Ramen”, etc. are included in the next hierarchy (depth level 3) as the children node of “Menu Guide”. Among the nodes of depth level 3, “Country of Origin”, “Allergy Information”, “How to eat deliciously”, “Other Compatible Dishes”, etc. are included in the next layer (depth level 4) as the children node of “Donkotsu Ramen”.

In the example of the illustrated tree, classification is made based on industry sectors at depth level 1. In addition, at depth level 2 or less, a tree of classifications is provided according to such industry sectors.

Further, an identifier for uniquely identifying the node is given for each node included in the field tree.

In this example, the maximum depth of the tree is set to 4, but the number of maximum depth levels is arbitrarily assigned. In addition, although an example here illustrates the form of linkage between sectors as a tree structure, it is better that other forms of fields are connected. In addition, in either case, an identifier (field data identification information) is assigned to one field (one node on the tree).

Also, it is not necessary to represent the connection between field data as a specific type of structure such as a tree structure. For example, it is sufficient that the field data set has a plurality of field data as elements without having a structure.

An exemplary embodiment of each functional unit comprising each device include the chat mediation server device 1, the chatbot ID management device 2, the chatbot server device 3, the terminal device 6, etc. Such functional unit, for example, is realized using an electronic circuit. Further, each functional unit may have a storage means such as a semiconductor memory or a self-hard-disk device therein as necessary. In addition, each functional unit may be realized by a computer and software.

When a computer has implemented at least some functions of each device, a program to implement this function may be recorded on a computer-readable recording medium, and the program recorded on the recording medium may be read and executed by a computer system. In addition, the term “computer system” referred to herein includes hardware such as an OS and peripheral devices. In addition, the term “computer-readable recording medium” refers to portable media such as flexible disks, magneto-optical disks, ROMs, CD-ROMs, DVD-ROMs, and USB memories etc., and storage devices such as hard disks built into computer systems. In addition, the term “computer-readable recording medium” refers to temporarily and dynamically storing and maintaining a program, such as a communication line when a program is transmitted via a network such as Internet or a communication line such as a telephone line. In this case, it may also include things that store a program for a certain time, such as volatile memory inside a computer system that becomes a server or client. Further, the program may be for implementing some of the above-described functions, or may be implemented by combining the above-described functions with a program already recorded in the computer system.

Although the embodiment has been described, the present invention can be further implemented in the following modified examples.

For example, in the chat system 100, the server-side functions are distributed to the chat mediation server device 1, the chatbot ID management device 2, and the chatbot server device 3, but configuration of server device may be arbitrary to implement such functions. That is, the specific functions shown in the present embodiment may be distributed to, for example, a plurality of computers (server devices), or may be integrated into a single computer (server device) by integrating a plurality of specific functions. Further, the hardware configuration (processing capability) may be dynamically changed according to the load on the server side.

According to the embodiment described above, the chat system 100 includes a chatbot server device 3, a chatbot ID management device 2, and a chat mediation server device 1.

The chatbot server device 3 includes at least an answer management unit 35, a field data management unit 37, an answer inference unit 34, and a field data inference unit 36. Here, the field data is data indicating a field such as a query.

The answer management unit 35 holds data indicating a relationship between query data (a query transmitted by the terminal device 6 side as a chat text) and answer data (a chat answer corresponding to the query). An example of data representing the relationship between query data and answer data is a machine-learned “model”.

The field data management unit 37 maintains data indicating a relationship between the query data and field data, which is information on the field to which the query data belongs. One example of data representing the relationship between query data and field data is a machine-learned “model”.

The answer inference unit 34 infers and outputs the answer data based on the query data transmitted by the terminal device 6 and the answer management unit 35.

The field data inference unit 36 infers field data based on the query data transmitted by the terminal device 6 and the field data management unit 37 and outputs it.

Thereby, the chatbot server device 3 can output not only answer data corresponding to the query data, but also field data indicating the field to which the query data belongs. As a result, the external device can find (search, etc.) another chatbot server device 3 matching the query data based on the field data output by the chatbot server device 3.

The chatbot ID management device 2 includes at least a chatbot ID management unit 23 and a chatbot ID transmission unit 24.

As described above, the chatbot ID management unit 23 stores and manages the chatbot ID and field data in association with each other. The chatbot ID is information for identifying the chatbot server device 3.

The chatbot ID transmission unit 24 outputs the chatbot ID corresponding to the field data, based on the output field data from the chatbot server device 3 after inferred by the field data inference unit (of the chatbot server device 3) in response to the query data transmitted by the terminal device 6, acquired from the chatbot ID management unit 23.

Thereby, the chatbot ID management device 2 can output information (chatbot ID) for identifying the chatbot server device 3 matching the received field data. The external device may specify the chatbot server device 3 suitable for field data based on the chatbot ID output from the chatbot ID management device 2.

The chat mediation server device 1 includes at least a query receiving unit 11, a query transmission unit 12, an answer receiving unit 13, an answer output unit 14, a field data transmission unit 15 and a chatbot ID receiving unit 16, an alteration unit (alteration chatbot information transmission unit 17 and alteration approval unit 18).

The query receiving unit 11 receives query data from the terminal device 6.

The query transmission unit 12 transmits the query data received by the query receiving unit 11 to the chatbot server device 3.

The answer receiving unit 13 receives the answer data inferred by the answer inference unit 34 (of the chatbot server device 3) and the field data inferred by the field data inference unit 36. However, there may be a case in which the chatbot server device 3 does not output field data, but only outputs answer data.

The answer output unit 14 transmits the answer data received by the answer receiving unit 13 to the terminal device 6.

The field data transmission unit 15 transmits the field data received by the answer receiving unit 13 to the chatbot ID management device 2.

The chatbot ID receiving unit 16 receives the chatbot ID from the chatbot ID management device 2 in response to the field data transmitted by the field data transmission unit 15.

The alteration unit may change the target chatbot server device 3 to receive the query data transmitted by the terminal device 6 based on the chatbot ID received by the chatbot ID receiving unit 16.

Thereby, the chat mediation server device 1 can change the chatbot server device 3 to which the terminal device 6 is connected, even in the middle of a chat service, for example.

Moreover, it may be used as the following form. The alteration unit of the chat mediation server device 1 receives query data. With respect to the original terminal device 6 that was transmitted, an attempt is made to obtain approval of whether to use the chatbot server device 3 indicated by the chatbot ID acquired by the chatbot ID receiver as a connection destination, and only when the approval is obtained, the chatbot server device where the query data is sent is changed.

Further, the alteration unit may omit the inquiry (obtain approval) of whether to change the chatbot server device 3 of the connection destination to the terminal device 6.

In addition, it may be used as the following form. That is, the chatbot server device 3 prevents the output of field data, which is a result of inference, when field data obtained as a result of inference matches with the field data. That is, the inference result transmission unit 33 stores the self-field data corresponding to the self-device and controls to output the field data to the outside only when the field data obtained by the field data inference unit is different from the field data. As a result, the chatbot server device 3 does not output field data related to the query as long as it receives a query belonging to the self-field data. Accordingly, a lengthy procedure for changing the chatbot server device 3 can be omitted.

In addition, the chatting method according to the present embodiment is as follows. However, each function of the chat mediation server device 1, the chatbot ID management device 2, and the chatbot server device 3 may be mounted on the same device (on a computer), or different devices (on a computer).

In the chatbot server device 3, which is a server of the chat service, the answer management unit 35 stores data representing the relationship between the query data and the answer data, and the field data management unit 37 stores the query data and the query data. Data representing the relationship with field data, which is field information, is stored, and the answer inference unit 34 outputs answer data based on the query data transmitted by the terminal device 6, which is the chat service client, and the answer management unit. Then, the field data inference unit 36 infers the field data based on the query data transmitted by the terminal device 6 and the field data management unit.

In addition, in the chatbot ID management device 2 for providing a chatbot ID based on field data, the chatbot ID management unit 23 associates and remembers the chatbot ID for identifying the field data and the chatbot server device 3.

In addition, in the chat mediation server device 1 which is the connection destination of the terminal device 6, the chatbot ID receiving unit 16 obtains the chatbot ID by referring to the chatbot ID management unit 23 based on the output field data from the field data inference unit 36 in response to the query data transmitted by the terminal device 6. The alteration unit changes the chatbot server device 3 that receives the query data transmitted by the terminal device 6 based on the chatbot ID acquired by the chatbot ID receiving unit 16.

As described above, embodiments of the present invention have been described in detail with reference to the drawings, but the specific configuration is not limited to this embodiment, and designs and the like within a range not departing from the gist of the present invention are also included.

### INDUSTRIAL APPLICABILITY

The present invention can be used, for example, in a business for providing information for customers, for suppliers, or for employees in various industries. However, the scope of use of the present invention is not limited to those illustrated here.

### REFERENCE SINGS LIST

1 Chat mediation server device
2 Chatbot ID management device
3, 3A, 3B, 3C, . . . Chatbot server device
6, 6A, 6B, 6C, . . . Terminal device
11 Query receiving unit
12 Query transmission unit
13 Answer receiving unit
14 Answer output unit
15 Field data transmission unit (answer data transmission unit)
16 Chatbot ID receiving unit
17 Alteration chatbot information transmission unit (alteration unit)
18 Alteration approval unit (alternation unit)
21 Receiving unit
22 Field data management unit
23 Chatbot ID management unit
24 Chatbot ID transmission unit
31 Query receiving unit
32 Inference engine unit
33 Inference result transmission unit
34 Answer inference unit
35 Answer management unit
36 Field data inference unit
37 Field data management unit
100 Chat system

1. A chat system comprising a chatbot server device, a chatbot ID management device, and a chat mediation server device,
The chatbot server device comprising:
an answer management unit for maintaining data representing a relationship between query data and answer data;
a field data management unit for maintaining data representing a relationship between the query data and field data, the field data being information on a field to which the query data belongs;
an answer inference unit for inferring answer data based on the query data transmitted by a terminal device and the answer management unit; and,
a field data inference unit for inferring field data based on the query data transmitted by the terminal device and the field data management unit,
The chatbot ID management device comprising:
a chatbot ID management unit for storing the field data in association with a chatbot ID for identifying the chatbot server device; and,
a chatbot ID transmission unit for outputting the chatbot ID corresponding to the field data based on the field data inferred by the field data inference unit in response to the query data transmitted by the terminal device and outputted from the chatbot server device,
The chat mediation server device comprising:
a query receiving unit for receiving the query data from the terminal device;
a query transmission unit for transmitting the query data received by the query receiving unit to the chatbot server device;
an answer receiving unit for receiving the answer data inferred by the answer inference unit and the field data inferred by the field data inference unit;
an answer output unit for transmitting the answer data received by the answer receiving unit to the terminal device;
a field data transmission unit for transmitting the field data received by the answer receiving unit to the chatbot ID management device;
a chatbot ID receiving unit for receiving the chatbot ID from the chatbot ID management device in response to the field data transmitted by the field data transmission unit; and,
an alteration unit for changing the chatbot server device that receives the query data transmitted by the terminal device based on the chatbot ID received by the chatbot ID receiving unit.

2. The chat system of claim 1, wherein the alteration unit attempts to obtain approval of whether or not the chatbot server device indicated by the chatbot ID acquired by the chatbot ID receiving unit is used as a connection destination for the original terminal device that has transmitted the query data, and changes the chatbot server device to which the query data is transmitted only when the approval is obtained.

3. The chat system of claim 1, wherein the chatbot server device stores self-field data, which is field data corresponding to a self-device,
and further includes an inference result transmission unit for controlling to output the field data to the outside only when the field data obtained by the field data inference unit through inference is different from the self-field data.

4. The chat system of claim 1, wherein the field data inference unit in the chatbot server device calculates an accuracy indicating the authenticity of the inferred field data,
the answer receiving unit in the chat mediation server device receives the accuracy together with the field data, and only when the accuracy is equal to or greater than a predetermined threshold, the field data transmission unit transmits the field data to the chatbot ID management device, the chatbot ID receiving unit receives the chatbot ID from the chatbot ID management device, and the alteration unit changes the chatbot server device that receives the query data transmitted by the terminal device.

5. A chatbot server device comprising:
an answer management unit for maintaining data representing the relationship between query data and answer data;
a field data management unit for maintaining a pre-machine-learned model, which is a model that outputs field data by inputting the query data, the field data being information on a field to which the query data belongs;
an answer inference unit for inferring answer data based on the query data transmitted by the terminal device and the answer management unit;
a field data inference unit for inferring field data based on the query data transmitted by the terminal device and the model maintained by the field data management unit, and outputting an accuracy indicating the authenticity of the field data and the field data.

6. The chatbot server device of claim 5, wherein the field data management unit trains the model in online learning during a chat.

7. A chatbot ID management device comprising:
a chatbot ID management unit for storing field data in association with a chatbot ID, the field data being information on a field to which query data transmitted by a terminal device as a client of a chat service belongs, and the chatbot ID being for identifying the chatbot server device as a server of the chat service;
a chatbot ID transmission unit for outputting the chatbot ID corresponding to the field data based on the field data inferred in response to the query data transmitted by the terminal device and outputted from the chatbot server device.

8. A chatbot mediation server device comprising:
a query receiving unit for receiving query data transmitted by a terminal device that is a client of a chat service;
a query transmission unit for transmitting the query data received by the query receiving unit to a chatbot server device that is a server of the chat service;
an answer receiving unit for receiving answer data corresponding to the query data and field data corresponding to the query data as a result inferred by the chatbot server device;
an answer output unit for transmitting the answer data received by the answer receiving unit to a terminal device;
a field data transmission unit for transmitting the field data received by the answer receiving unit to a chatbot ID management device;
a chatbot ID receiving unit for receiving a chatbot ID from the chatbot ID management device in response to the field data transmitted by the field data transmission unit,
an alteration unit for changing the chatbot server device that receives the query data transmitted by the terminal device based on the chatbot ID received by the chatbot ID receiving unit.

9. A computer-readable program stored in medium for causing a computer to function as a chatbot server device, the chatbot server device comprising:
an answer management unit for maintaining data representing the relationship between query data and answer data,
a field data management unit for maintaining a pre-machine-learned model, which is a model that outputs field data, which is information on a field to which the query data belongs by inputting the query data;
an answer inference unit for inferring answer data based on the query data transmitted by the terminal device and the answer management unit,
a field data inference unit for inferring field data based on the query data transmitted by the terminal device and the model maintained by the field data management unit and outputting the field data and an accuracy indicating the authenticity of the field data.

10. The program stored in medium of claim 9, wherein the field data management unit trains the model in online learning during a chat.

11. A computer-readable program stored in medium for causing a computer to function as a chatbot ID management device, the chatbot ID management comprising:
a chatbot ID management unit for storing the field data in association with a chatbot ID, the field data being information on a field to which query data transmitted by a terminal device as a client of a chat service belongs, and the chatbot ID being for identifying the chatbot server device as a server of the chat service;
a chatbot ID transmission unit for outputting the chatbot ID corresponding to the field data based on the field data outputted from the chatbot server device in response to the query data transmitted by the terminal device.

12. A computer-readable program stored in medium for causing a computer to function as a chatbot mediation server device, the chatbot mediation server device comprising:
a query receiving unit for receiving query data transmitted by a terminal device that is a client of a chat service;
a query transmission unit for transmitting the query data received by the query receiving unit to a chatbot server device, which is a server of the chat service,
an answer receiving unit for receiving answer data corresponding to the query data and field data corresponding to the query data as a result inferred by the chatbot server device;
an answer output unit for transmitting the answer data received by the answer receiving unit to the terminal device,
a field data transmission unit for transmitting the field data received by the answer receiving unit to a chatbot ID management device,
a chatbot ID receiving unit for receiving a chatbot ID from the chatbot ID management device in response to the field data transmitted by the field data transmission unit;
an alteration unit for changing the chatbot server device that receives the query data transmitted by the terminal device based on the chatbot ID received by the chatbot ID reception device.

13. A chat method for causing a chat system to execute a chat service, the chat system comprising a chatbot server, a chatbot ID management device and a chat mediation service device,
the chatbot server device that is a server of the chat service, comprising:
an answer management unit maintains data indicating the relationship between the query data and the answer data,
a field data management unit maintains data indicating a relationship between the query data and field data, which is information on a field to which the query data belongs,
an answer inference unit outputs answer data based on the query data transmitted by the terminal device, which is a client of the chat service, and the answer management unit,
a field data inference unit infers field data based on the query data transmitted by the terminal device and the field data management unit,
the chatbot ID management device for providing a chatbot ID based on the field data, comprising:
a chatbot ID management unit for storing field data in association with the chatbot ID for identifying the chatbot server device,
the chat mediation server device to which a terminal device is connected, comprising:
a chatbot ID receiving unit acquires the chatbot ID which can be obtained by referring to the chatbot ID management unit based on the field data outputted from the field data inference unit in response to the query data transmitted by the terminal device,
an alteration unit changes the chatbot server device for receiving the query data transmitted by the terminal device based on the chatbot ID obtained by the chatbot ID receiving unit.

14. A method of chat mediation in which a chat mediation server device mediates between the terminal device and the chatbot server device comprising:
a query receiving unit receives a query from the terminal device,
a query transmission unit transmits the query received by the query receiving unit to the selected chatbot server device,
an answer receiving unit receives an inference result including an answer to the query, field data related to the query, and an accuracy indicating the authenticity of the field data as a result of inference processing based on the query from the chatbot server device to which the query is transmitted,
a field data transmission unit transmits the field data included in the inference result to the chatbot ID management device only when the accuracy received by the answer receiving unit is greater than or equal to a predetermined threshold,
a chatbot ID receiving unit receives the chatbot ID representing a candidate for changing the connection destination of the chatbot server device in response to the transmitted field data from the chatbot ID management device,
an answer output unit transmits the answer included in the inference result to the terminal device,
an alteration unit changes the chatbot server device that receives the query transmitted by the terminal device based on the chatbot ID acquired by the chatbot ID receiving unit when the chatbot ID receiving unit is receiving the chatbot ID.
